(19) United States
(12) Patent Application Publication
(10) Pub. No.: US 2022/0048770 A1
(43) Pub. Date: Feb. 17, 2022

(54) CARBON FOAM FROM BLENDED COALS

(71) Applicant: Touchstone Research Laboratory, Ltd., Triadelphia, WV (US)

(72) Inventor: Dwayne R. Morgan, Wheeling, WV (US)

(21) Appl. No.: 16/947,736

(22) Filed: Aug. 14, 2020

(51) Int. Cl. C01B 32/05; C04B 38/00

(52) U.S. Cl. CPC C01B 32/05; C01P 2006/10; C04B 38/0022; C04B 38/0067

(57) ABSTRACT

Disclosed are methods for producing carbon foam in which using the vitrinite reflectance values of coals are used to form a blended coal precursor having a targeted vitrinite reflectance value. The targeted vitrinite reflectance value can be used to create similar carbon foam products from one production batch to the next.

### FIELD OF THE INVENTION

The present invention directed to low density, high strength carbon foams prepared by the controlled foaming of a blend of comminuted coals where each of the comminuted coals in the blended coal starting material each have different properties.

### BACKGROUND OF THE INVENTION

Carbon foams are materials of very high carbon content that have appreciable void volume. In appearance, excepting color, carbon foams resemble some readily available commercial plastic foams. As with plastic foams, the void volume of carbon foams is located within numerous empty cells. The boundaries of these cells are defined by the carbon structure. These cells typically approximate ovoids of regular, but not necessarily uniform, size, shape, distribution, and orientation. The void volumes in these cells may directly connect to neighboring void volumes. Such an arrangement is referred to as an open-cell foam. The carbon in these foams forms a structure that is continuous in three dimensions across the material. Typically, the cells in carbon foams are of a size that is readily visible to the unaided human eye. Also, the void volume of carbon foams is such that it typically occupies much greater than one-half of the carbon foam volume.

The regular size, shape, distribution, and orientation of the cells within carbon foam readily distinguish this material from other carbon materials such as metallurgical cokes. The void volumes within cokes are contained in cell-like areas of typically ovoid shape and random size, distribution, and orientation. That is, in cokes, some void volumes can be an order of magnitude, or more, larger than others. It is also not uncommon that the over-lapping of void volumes in cokes results in significant distortions in the void shape. These distortions and large void volumes can even lead to a product that has limited structural integrity in all except smaller product volumes. That is, it is not uncommon for coke to be friable and larger pieces of coke to readily break into smaller pieces with very minimal handling. Such breakage is typically not exhibited by carbon foams. Also, a given sample of coke can exhibit both open and closed-cell void volumes.

Carbon foams have potential utility in a variety of applications as a result of their unique properties such as temperature resistance, strength, and low density. For example, carbon foams are typically fire resistant and may exhibit significant strength, even at extreme temperatures, which makes these materials suitable for use as lightweight thermal barriers, wall panels, and as baffles for high intensity flames. These materials may also function as filter media for the removal of gross solid contaminates from molten metals.

Carbon foams have been produced by a variety of methods. Some of these methods include producing carbon foams directly from particulate coal. For example, U.S. Pat. Nos. 6,749,652 and 6,814,765, each herein incorporated by reference in their entirety, describe methods for producing carbon foam directly from particulate coal. To produce carbon foam from particulate coal, typically, a suitable swelling coal, such as bituminous coal, is heated in an essentially closed vessel. The particulate coal is placed in a mold and is heated in an inert atmosphere under process atmospheric pressures typically greater than ambient and can reach pressures of about 500 psi or greater. The particulate coal is heated to temperatures sufficient to cause the coal to become plastic and swell, forming a carbon foam. In many instances heating the particulate coal to a temperature between about 300° C. and about 500° C. is sufficient to form a carbon foam material. The temperatures and pressure conditions will vary depending upon the characteristics of the particulate coal. The resultant carbon foam may subsequently be heated under an essentially inert, or otherwise non-reactive, atmosphere, to temperatures as great as about 3000° C. Heating of the carbon foam to such elevated temperatures has been found to improve certain properties of the foam. Such properties have included, but are not limited to, electrical resistance and strength.

While the methods and products described in the foregoing U.S. patents are entirely satisfactory for the production of carbon foam, the starting coals used as the starting material can have different properties from one production run to the next. This variation in properties of the starting coal material results in deviations in the properties of the resultant carbon foam. These deviations in starting coal properties make it difficult to produce carbon foam having consistent properties from one batch or run to the next. To get consistent results, the foaming or swelling process is typically modified until the desired result is achieved. Modifying the process conditions is costly in terms of time and resources. Similarly, if a desired property of carbon foam is required, different coal starting materials are tried along with variations in the foam production process until the desired carbon foam properties are achieved.

### SUMMARY OF THE INVENTION

Embodiment of the invention may include a method for producing carbon foam, comprising the steps of blending a first comminuted coal having a first vitrinite reflectance value with a second comminuted coal having a second vitrinite reflectance value that is different than the first vitrinite reflectance value to provide a blended coal precursor having an overall vitrinite reflectance value wherein at least one of the first comminuted coal and the second comminuted coal is a swelling coal and heating the blended coal precursor in a mold under a non-oxidizing atmosphere and under a pressure ranging of at least about 50 psi to a final temperature ranging from about 300 C to about 700 C, and wherein the resulting carbon foam has an average overall density ranging from 0.1 g/cc to about 1.6 g/cc.

Further, embodiments of the inventions may include a method for producing carbon foam, comprising the steps of selecting two or more different comminuted coals where at least one comminuted coal is a swelling coal and at least two of the selected comminuted coals have different vitrinite reflectance values; blending the selected coal particulates to form a blended coal precursor comprising from about 10 to about 90 weight percent swelling coal particulate such that the blended coal precursor has a predetermined overall vitrinite reflectance; heating the blended coal precursor in a mold and under a non-oxidizing atmosphere at a heat up rate of from about 1 to about 20° C./min to a temperature at least above an initial plastic temperature of the swelling coal; and soaking at a temperature of between about 300 and 700° C. from about 10 minutes up to about 12 hours to form a green foam.

### BRIEF DESCRIPTION OF THE FIGURES

FIG. 1 is a plot of overall vitrinite reflectance vs. carbon foam density in accordance with an embodiment of the invention.

### DETAILED DESCRIPTION OF THE INVENTION

It is desirable to provide a process whereby consistent carbon foam properties may be achieved using different coal starting materials. Additionally, the ability to better tailor the foregoing properties to meet specific requirements is also highly desirable.

It is therefore an object of the present invention to provide coal-based carbon foams produced from starting materials that permit better control of and variation in carbon foam properties, such as carbon foam density, to meet specific end use requirements. The present invention provides a process that enables increased control of the properties of carbon foam through coal selection and blending without substantial changes the carbon foam swelling or foaming process.

Some preferred embodiments of the present invention are described in this section in detail sufficient for one skilled in the art to practice the present invention without undue experimentation. It is to be understood, however, that the fact that a limited number of preferred embodiments are described in this section does not in any way limit the scope of the present invention as set forth in the claims.

It is to be understood that whenever a range of values is described herein, i.e. whether in this section or any other part of this patent document, that the range includes the end points and every point therebetween as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present invention.

As used herein “carbon foam” refers to a porous carbon material with a regular and homogeneous distribution of open cells throughout the carbon body resulting from the controlled swelling of the coal precursor and may range from about 0.1 to about 1.6 g/cc. Within this range, carbon foams exhibiting densities ranging from about 0.1 to about 0.8 g/cc may be referred to as low density carbon foams, and those with densities above 0.8 g/cc may also be referred to as high density carbon foams.

The present invention is directed to the production of carbon foam by blending a first comminuted coal having a first vitrinite reflectance value with a second comminuted coal having a second vitrinite reflectance value that is different than the first vitrinite reflectance value to provide a blended coal precursor having an overall vitrinite reflectance value. Either the first comminuted coal or the second comminuted coal is a swelling coal. The blended coal precursor is heated in a mold under controlled conditions to produce a carbon foam.

The starting material coals may include bitumen, subbituminous, anthracite, or lignite. The present invention utilizes the vitrinite reflectance value of the coals to produce a blended coal precursor of at least two different comminuted coal sources. Vitrinite reflectance is a measurement of the optical properties of coal. As used herein vitrinite reflectance is the value obtained in accordance with ASTM D2798-11a, herein incorporated by reference in its entirety.

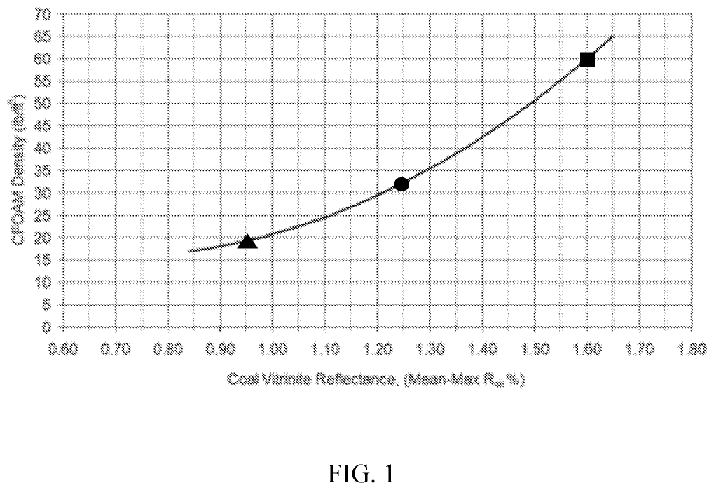

Based on the desired density of the carbon foam, an overall vitrinite reflectance value is chosen. With reference to FIG. 1, there is shown a plot of overall vitrinite reflectance versus carbon foam density for carbon foam made in accordance with the method described herein. The relationship between the overall vitrinite reflectance and resulting carbon foam density may change slightly with changes in carbon foam processing conditions. As used herein, “overall vitrinite reflectance value” is the combination of the vitrinite reflectance values of each of the comminuted coal sources being blended based on the weight percent of each comminuted coal source in the blend. Vitrinite reflectance is typically provided as Rₒᵢₗ%. A wide variety of comminuted coal sources may be used provided the blended coal precursor provides an overall about 1.6 Rₒᵢₗ%. For carbon foam exhibiting densities between about 0.3 g/cc to about 0.5 g/cc, the overall vitrinite reflectance value is preferably in a range from about 0.93 Rₒᵢₗ% to about 1.23 Rₒᵢₗ%. For carbon foam exhibiting densities between about 0.8 g/cc to about 1 g/cc, the overall vitrinite reflectance value is preferably between about 1.49 Rₒᵢₗ% and about 1.63 Rₒᵢₗ%. In certain embodiments, an overall vitrinite reflectance value of about 0.9 Rₒᵢₗ% to about 1.0 Rₒᵢₗ% provide carbon foams having a density of about 0.3 g/cc. In other embodiments the overall vitrinite reflectance value of about 1.2 Rₒᵢₗ% to about 1.3 Rₒᵢₗ% provide carbon foams having a density of about 0.5 g/cc. Still further, in some embodiments, an overall vitrinite reflectance value of about 1.4 Rₒᵢₗ% to about 1.5 Rₒᵢₗ% provide carbon foams having a density of about 0.8 g/cc, and overall vitrinite reflectance value of about 1.6 Rₒᵢₗ% to about 1.7 Rₒᵢₗ% provide carbon foams having a density of about 1.0 g/cc.

In some embodiments, the size of particles in the comminuted coal source may range from about 0.020 mm (or less) to about 0.5 mm. In certain embodiments, the coal is comminuted to a size such that essentially all of the coal will pass through an 80 mesh screen (U.S. Standard Sieve Series). Such 80 mesh screens have openings of about 0.18 mm. In other embodiments, the coal is comminuted to a size such that essentially all of the coal will pass through a 140 mesh screen (U.S. Standard Sieve Series). Such 140 mesh screens have openings of about 0.105 mm. In still other embodiments, suitable coals comminuted to other mesh sizes may be utilized. In various embodiments, the coal may be comminuted to sizes below about 0.42 mm, in other embodiments below about 0.18 mm, and in yet other embodiments below about 0.105 mm. In some embodiments, coals comminuted to larger particle size distributions will provide carbon foams having larger cell sizes. In other embodiments, coals comminuted to smaller particle size distributions will provide carbon foams having smaller cell sizes.

At least one of the comminuted coals in the blended coal precursor should be a swelling coal. In some embodiments, the swelling coal is an agglomerating coal exhibiting a Free Swell Index as determined by ASTM D720 greater than about 0.5 and in some embodiments, between about 3.5 and about 5.0, and in additional embodiments between about 3.75 and 4.5. Suitable swelling coals may include, but are not limited to, Low Volatile, Medium Volatile, High Volatile A, High Volatile B, and High Volatile C bituminous coals exhibit the above coking or Free Swell Index properties.

Blending of the selected coal particulates to form the blend coal precursor can be obtained using any conventional blending apparatus of the type generally applied in the art to obtain uniform blends of particulate materials.

In certain embodiments, the production method of the present invention comprises: 1) selecting two or more different comminuted coals where at least one comminuted coal is a swelling coal and at least two of the selected comminuted coals have different vitrinite reflectance values; 2) blending the selected coal particulates to form a blended coal precursor comprising from about 10 to about 90 weight percent swelling coal particulate such that the blended coal precursor has a predetermined overall vitrinite reflectance; 3) heating the blended coal precursor in a mold and under a non-oxidizing atmosphere at a heat up rate of from about 1 to about 20° C./min. to a temperature at least above the initial plastic temperature of the swelling coal, typically between about 300 and about 700° C.; 4) soaking at a temperature of between about 300 and 700° C. from about 10 minutes up to about 12 hours to form a “green foam”; and 5) controllably cooling the “green foam” to a temperature below about 100° C. The non-oxidizing atmosphere may be provided by the introduction of inert or non-oxidizing gas into the “mold” at a pressure of from about 0 psi, i.e., free flowing gas, up to about 500 psi. The inert gas used may be any of the commonly used inert or non-oxidizing gases such as nitrogen, helium, argon, etc.

The “initial plastic temperature” of the swelling coal is that temperature at which the particles of the swelling coal in the blended coal precursor begins to soften and becomes sufficiently plastic to adhere to each other. The initial plastic temperature may vary depending on the coal and process conditions. For most agglomerating bituminous coals, the value of the initial plastic temperature ranges from about 300° C. to about 350° C. Some bituminous coals can exhibit initial plastic temperatures outside this range. In particular, some high rank bituminous coals will exhibit initial plastic temperatures at values above about 350° C. The specific value of the initial plastic temperature for a given coal may be established experimentally for a given coal at the selected process conditions by methods known to those skilled in the art.

The term “mold”, as used herein is meant to define a mechanism for providing controlled dimensional forming of the expanding coal. Thus, any chamber into which the coal/petroleum pitch particulate blend is deposited prior to or during heating and which, upon the “green blend” attaining the appropriate “encapsulation” and expansion temperatures, contains and shapes the expanding porous coal to some predetermined configuration such as: a flat sheet; a curved sheet; a shaped object; a building block; a rod; tube or any other desired solid shape can be considered a “mold” for purposes of the instant invention.

It is generally not desirable that the reaction chamber or mold be vented or leak during the heating and soaking operations. The pressure of the chamber and the increasing volatile content therein tends to retard further volatilization while the carbon foam sinters at the indicated elevated temperatures. If the furnace is vented or leaks during soaking, an insufficient amount of volatile matter may be present to permit inter-particle sintering of the coal particles thus resulting in the formation of a sintered powder as opposed to the desired cellular product. Thus, according to a preferred embodiment of the present process, venting or leakage of non-oxidizing gas and generated volatiles is inhibited consistent with the production of an acceptable cellular product or foam. Additional more conventional blowing agents may be added to the particulate blend prior to expansion to enhance or otherwise modify the pore-forming operation. Cooling of the green foam after soaking is not particularly critical except as it may result in cracking of the green foam as the result of the development of undesirable thermal stresses. Cooling rates less than 10° C./min to a temperature of about 100° C. are typically used to prevent cracking due to thermal shock.

After expanding the blended coal precursor to form the green foam as just described, the porous or foamed product is largely an open celled carbon foam material. Subsequent to production of the green foam as just described, it may be subjected to carbonization and/or graphitization according to conventional processes to obtain particular properties desirable for specific applications of the type described hereinafter. Ozonation may also be performed, if activation of the green foam would be useful in a final product application such as in filtering of air. Additionally, a variety of additives and structural reinforcers may be added to the blended coal precursor either before or after expansion to enhance specific mechanical properties such as fracture strain, fracture toughness and impact resistance. For example, particles, whiskers, fibers, plates, etc. of appropriate carbonaceous or ceramic composition can be incorporated into the green foam to enhance its mechanical properties.

The carbon foams, of the present invention can additionally be impregnated with, for example, additional petroleum pitch, epoxy resins or other polymers using a vacuum assisted resin transfer type of process. The incorporation of such additives provides load transfer advantages similar to those demonstrated in carbon composite materials. In effect a 3-D composite is produced that demonstrates enhanced impact resistance and load transfer properties.

Carbonization, sometimes referred to as calcining, is conventionally performed by heating the green foam under an appropriate inert gas at a heat-up rate of less than about 5° C. per minute to a temperature of between about 800° C. and about 1200° C. and soaking for from about 1 hour to about three or more hours. Appropriate inert gases are those described above that are tolerant of these high temperatures. The inert atmosphere is supplied at a pressure of from about 0 psi up to a few atmospheres. The carbonization/calcination process serves to remove all of the non-carbon elements present in the green foam such as sulfur, oxygen, hydrogen, etc.

Graphitization, commonly involves heating the green foam either before or after carbonization at heat-up rate of less than about 10° C. per minute, preferably from about 1° C. to about 5° C. per minute, to a temperature of between about 1700° C. and about 3000° C. in an atmosphere of helium or argon and soaking for a period of less than about one hour. Again, the inert gas may be supplied at a pressure ranging from about 0 psi up to a few atmospheres.

The carbon foams resulting from processing in accordance with the foregoing procedures can be used in a broad variety of product applications, including composite tooling, filters, and thermal protection systems.

As the invention has been described, it will be apparent to those skilled in the art that the same may be varied in many ways without departing from the spirit and scope of the invention. Any and all such modifications are intended to be included within the scope of the appended claims.

What is claimed is:

1. A method for producing carbon foam, comprising the steps of:
blending a first comminuted coal having a first vitrinite reflectance value with a second comminuted coal having a second vitrinite reflectance value that is different than the first vitrinite reflectance value to provide a blended coal precursor having an overall vitrinite reflectance value wherein at least one of the first comminuted coal and the second comminuted coal is a swelling coal; and
heating the blended coal precursor in a mold under a non-oxidizing atmosphere and under a pressure ranging of at least about 50 psi to a final temperature ranging from about 300 C to about 700 C, and wherein the resulting carbon foam has an average overall density ranging from 0.1 g/cc to about 1.6 g/cc.

2. The method of claim 1 wherein the overall vitrinite reflectance value is up to 1.1 Rₒᵢₗ% and wherein the average overall density of the carbon foam has a value ranging from about 0.27 g/cc to about 0.4 g/cc.

3. The method of claim 1 wherein the overall vitrinite reflectance value is between about 1.1 Rₒᵢₗ% and about 1.6 Rₒᵢₗ% and wherein the average overall density of the carbon foam has a value ranging from about 0.4 g/cc to about 1 g/cc.

4. The method of claim 1 wherein the swelling coal is selected from the group consisting of bituminous coal and subbituminous coal.

5. The method of claim 1 wherein at least one of the first comminuted coal and second comminuted coal is a non-swelling coal.

6. The method of claim 1 wherein the first vitrinite reflectance value is greater than the second vitrinite reflectance value.

7. The method of claim 1 wherein the swelling coal exhibits a Free Swell Index value greater than about 0.5.

8. The method of claim 1 wherein the swelling coal exhibits a Free Swell Index value ranging from about 3.5 to about 5.0.

9. The method of claim 1 wherein the swelling coal is a bituminous coal exhibiting a Free Swell Index value ranging from about 3.5 to about 5.0.

10. A method for producing carbon foam, comprising the steps of:
selecting two or more different comminuted coals where at least one comminuted coal is a swelling coal and at least two of the selected comminuted coals have different vitrinite reflectance values;
blending the selected coal particulates to form a blended coal precursor comprising from about 10 to about 90 weight percent swelling coal particulate such that the blended coal precursor has a predetermined overall vitrinite reflectance;
heating the blended coal precursor in a mold and under a non-oxidizing atmosphere at a heat up rate of from about 1 to about 20° C./min to a temperature at least above an initial plastic temperature of the swelling coal; and
soaking at a temperature of between about 300 and 700° C. from about 10 minutes up to about 12 hours to form a green foam.
